(19) United States
(12) Patent Application Publication
(10) Pub. No.: US 2006/0001350 A1
(43) Pub. Date: Jan. 5, 2006

(54) Field emission electron gun and electron beam apparatus using the same

(75) Inventors: Tadashi Fujieda, Mito (JP); Kishio Hidaka, Hitachiota (JP); Mitsuo Hayashibara, Hitachinaka (JP)

Correspondence Address: MCDERMOTT WILL & EMERY LLP, 600 13TH STREET, N.W., WASHINGTON, DC, 20005-3096, US

(73) Assignee: HITACHI HIGH-TECHNOLOGIES CORPORATION

(21) Appl. No.: 11/169,785

(22) Filed: Jun. 30, 2005

(30) Foreign Application Priority Data
Jun. 30, 2004 (JP) 2004-192454

(51) Int. Cl. H01J 1/304

(52) U.S. Cl. 313/441; 313/309

(57) ABSTRACT

A field emission electron gun has a field emission cathode composed of a carbon fiber and a conductive base for supporting the carbon fiber, an extractor for causing the field emission of electrons, and an accelerator for accelerating the electrons. The carbon fiber contains at least one of trivalent and pentavalent elements. In particular, the trivalent and pentavalent elements are boron and/or nitrogen. The content of at least one of boron and nitrogen in the carbon fiber is 0.1% to 5% at an atomic weight ratio of the contained element to carbon. The diameter of the carbon fiber is 20 nm to 200 nm. Such an electron gun can have a high-brightness electron beam with a narrow energy width. The field emission electron gun is applied to various electron beam apparatus.

### CLAIM OF PRIORITTY

The present application claims priority from Japanese application serial no. 2004-192454, filed on Jun. 30, 2004, the content of which is hereby incorporated by reference into this application.

### FIELD OF THE INVENTION

The present invention relates to a field emission electron gun and to an electron beam apparatus in which the field emission electron gun is mounted.

### BACKGROUND OF THE INVENTION

A field emission cathode used for the electron gun is comprised carbon fiber (ex. carbon nanotube) and a conductive base for supporting the carbon fiber. Since the carbon fiber has an extremely small tip diameter at the nano-scale level, its emission current is high and its virtual light source size is small. Therefore, it has been known that, when the carbon fiber is applied to the electron source of an electron microscope, a high-brightness electron beam is obtainable therefrom (Niels de Jonge, J. Appl. Phys. 95, 673 (2004) (Non-Patent Document 1)). In order to increase the resolution of the electron microscope, it is necessary for electrons emitted from the electron source to have a narrow energy width. However, since the energy width of electrons emitted from a carbon fiber electron source is equal to that of electrons emitted from a conventional tungsten electron source, the achievement of a higher resolution cannot be expected.

On the other hand, Japanese Unexamined Patent Publication No. 2003-36805 (Patent Document 1) discloses that a surface electron source containing at least one selected from the group consisting of boron and nitrogen in conjunction with carbon is used as an electron source for an extremely small X-ray source to be used in X-ray spectroscopic analysis or the like. The surface electron source can make electron emission efficiency to improve.

However, neither of the foregoing documents has mentioned that the energy width of emitted electrons can be narrowed by doping carbon with boron or with nitrogen. Only the surface electron source has been mentioned and an electron source for an electron microscope has not been mentioned.

### SUMMARY OF THE INVENTION

In order to implement an electron microscope capable of providing a high-brightness and high-resolution microscopic image, and to implement an electron beam lithography system capable of high-definition lithography, it is indispensable to mount an electron gun capable of providing a high-brightness electron beam with a narrow energy width.

A first object of the present invention is to provide a field emission electron gun capable of providing a high-brightness electron beam with a narrow energy width.

A second object of the present invention is to provide an electron beam application apparatus in which the field emission electron gun is mounted.

Means for attaining the first object of the present invention is a field emission electron gun comprising a field emission cathode composed of a carbon fiber and a conductive base for supporting the carbon fiber, an extractor for causing the field emission of electrons, and an accelerator for accelerating the electrons. Furthermore, the carbon fiber contains at least one of trivalent and pentavalent elements. In particular, the trivalent and pentavalent elements are preferably boron and nitrogen.

Each electron gun according to the present invention has a length of the carbon fiber serving as an electron source. The content of at least one of boron and nitrogen in the carbon fiber is 0.1% to 5% at an atomic weight ratio of the contained element to carbon, and the diameter of the carbon fiber is 20 nm to 200 nm.

On the other hand, in the field emission electron gun comprising the field emission cathode composed of a length of carbon fiber and a conductive base for supporting the carbon fiber, an extractor for causing the field emission of electrons, and an accelerator for accelerating the electrons, the following technical matter is provided. Namely, it is configured so that when the emission current of the field emission electrons from the carbon fiber is 10 nA, the energy half-width of the field emission electrons is 0.25 eV or less.

Assuming a square with sides each equal to the radius of a sphere, a portion with an area equal to the square on the surface of the sphere, and the center of the sphere as a vertex, the sr is defined as a solid angle of the vertex to the portion equal to the square on the surface of the sphere.

Means for attaining the second object of the present invention is to apply the field emission electron gun according to the present invention to various electron beam apparatus.

The present invention is capable of providing a field emission electron gun which emits a high-brightness electron beam with a narrow energy width, a field emission electron microscope, a length-measuring SEM, and an electron beam lithography system each using the field effect electron gun.

### BRIEF DESCRIPTION OF THE DRAWINGS

FIG. 1 shows a structure of an electron gun according to an embodiment of the present invention;

FIG. 2 shows a structure of a magnetic-field-immersion-type electron gun according to the embodiment;

FIGS. 3A and 3B show SEM photographs of the tip portion of a field emission cathode according to the embodiment;

FIG. 4a and 4b show TEM photographs of carbon fibers containing nitrogen according to the embodiments;

FIG. 5 shows a distribution of the density of states of free electrons in a carbon fiber doped with a trivalent or pentavalent element such as boron or nitrogen, a potential distribution relative to electrons which are field emitted from the carbon fiber, and an energy distribution of the field emission electrons, each according to the embodiment;

FIG. 6 shows the effect of nitrogen doping exerted on the energy distribution of the field emission electrons in the carbon fiber according to the embodiment;

FIG. 7 shows the effect of nitrogen doping exerted on the dependence of ΔE on an emission current in the carbon fiber according to the embodiment;

FIG. 8 is an overall structural view of a scanning electron microscope (SEM) using the electron gun according to the embodiment;

FIG. 9 is an overall structural view of an electron beam lithography system using the electron gun according to the embodiment; and

FIG. 10 is a structural view of an electro-optical system in an electron beam lithography system in which a plurality of the independently operating electron guns according to the embodiment are mounted.

### DESCRIPTION OF THE PREFERRED EMBODIMENT

Referring now to the drawings, a detailed description will be given to an embodiment of the present invention.

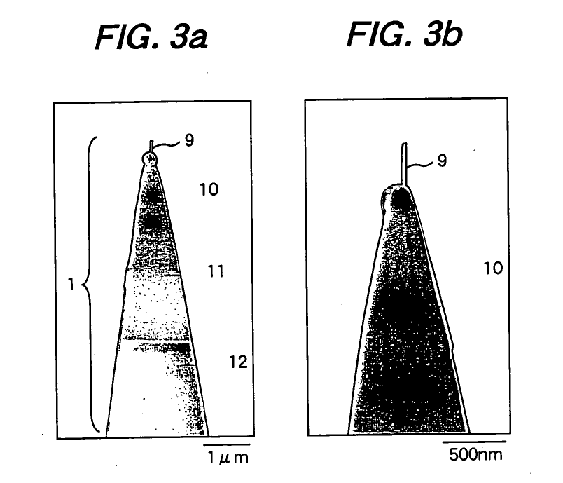

FIG. 1 shows a structure of an electron gun according to the present embodiment. The electron gun according to the present embodiment is comprised of: a field emission cathode 13 having a length of carbon fiber 9 (shown in FIGS. 3a and 3b) containing at least one of boron and nitrogen as trivalent and pentavalent elements and a conductive base 12 (shown in FIG. 3a) for supporting the carbon fiber (a reference number 1 shows the conductive with the carbon fiber); an extractor (4, 6) for causing the field emission of electrons; and an accelerator (5, 7) for accelerating the electrons. However the structure of the electron gun according to the present embodiment is not limited thereto, any electron guns can be adopted for the present embodiment if they can make the most of the characteristic of field electron emission from the field emission cathode.

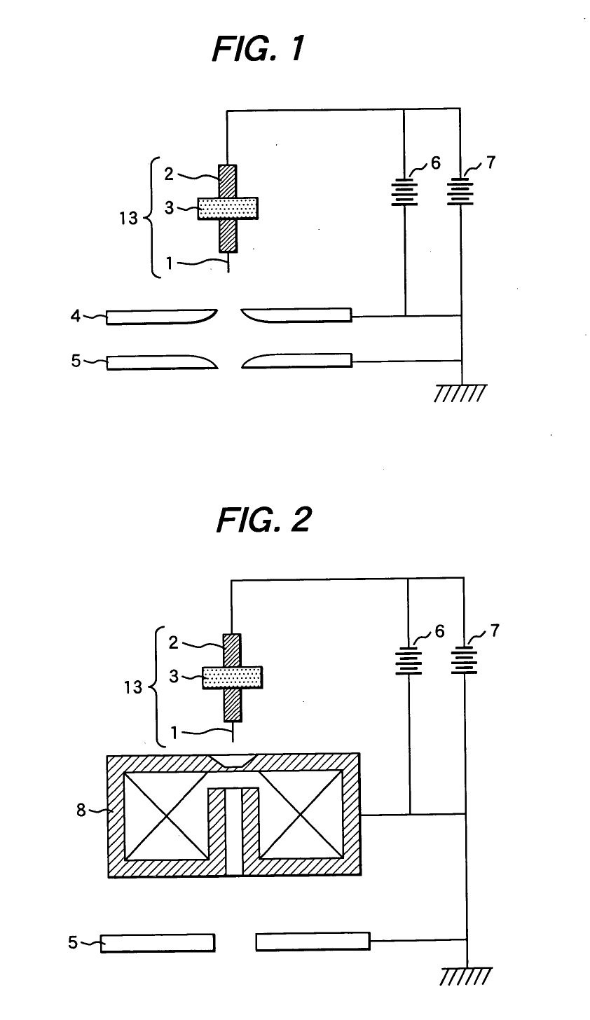

Instead of an electrostatic-type structure shown in the present embodiment, the electron gun may also have, e.g., a magnetic-field-immersion-type structure as shown in FIG. 2, in which a magnetic field lens 8 with a smaller spherical aberration is provided in place of the extraction electrode 4.

FIGS. 3A and 3B show SEM photographs of the tip portion of the field emission cathode 13 using the carbon fiber 9 doped with nitrogen according to the present embodiment. The field emission cathode 13 is composed of: the carbon fiber 9; the conductive base 12; an electrode 2; and an insulating holder 3 for supporting the electrode. The bonded portion between the carbon fiber 9 and the conductive base 12 has been reinforced by a conductive coating layer 10.

The material of the conductive base 12 is not particularly limited. However, a precious metal (which is specifically gold, silver, or a platinum group metal), crystalline carbon, or a refractory metal (which is specifically tungsten, tantalum, niobium, molybdenum, or the like) is preferred in terms of a melting point, oxidation resistance, and a mechanical strength.

In order to allow control of an angle formed between the center axis of the conductive base 12 and the carbon fiber 9, the tip portion of the conductive base 12 that has been sharpened by chemical etching or the like is formed with a flat surface 11 by FIB processing or the like. If consideration is given to the radiation angle of an electron beam emitted from the carbon fiber 9, the adjustment of the optical axis of an electron beam becomes difficult unless the angle formed between the center axis of the conductive base 12 and the carbon fiber 9 is set to ±5° or less.

Preferably, an oxide film or a carbon contamination layer formed on the surface to be bonded of each of the carbon fiber 9 and the conductive base 12 is maximally removed therefrom before the carbon fiber 9 is bonded to the conductive base 12. This is because, if the carbon fiber 9 is bonded to the conductive base 12 with the oxide film or carbon contamination layer having a high electric resistivity interposed therebetween, the following problems occur: (1) The contact electric resistance between the carbon fiber and the conductive base increases to hinder electron emission. As a result an emission current is saturated so that a large emission current is not obtainable. (2) In the case where the emission current is increased, heat generation at the bonded portion destroys the carbon fiber or the conductive base. (3) In the case where the emission current is increased, the emission of thermoelectrons from the carbon fiber simultaneously occurs with a temperature increase caused in the carbon fiber by the heat generation at the bonded portion. Consequently, the energy width of the emitted electrons is extremely increased.

It is to be noted that the carbon contamination layer mentioned above indicates a layer of amorphous carbon with a high electric resistivity which is formed through the decomposition of hydrocarbon or the like remaining in an electron-microscope specimen chamber by the electron beam in the step of bonding the carbon fiber to the conductive base in an electron microscope.

The oxide film and the carbon contamination layer, each having a high electric resistivity, can be removed by methods as will be described herein below: (1) An ion sputtering process is performed with respect to the bonded portion of the conductive base. (2) These layers are heated to a temperature where they are decomposed and evaporated. (3) A voltage is applied between the carbon fiber and the conductive base to cause the field emission of electrons from the carbon fiber and thereby remove the carbon contamination layer on the surface of the bonded portion of the carbon fiber therefrom.

When the extraction voltage is increased to increase the emission current from the carbon fiber and thereby stabilize the emission current, an electrostatic force (attracting force) resulting from an electric field exerted between the carbon fiber and the extraction electrode also increases. Accordingly there is a case where the carbon fiber is become separated from the conductive base. To prevent this, it is necessary to ensure the achievement of a sufficient bonding strength by forming a conductive coating layer 10 at least a part of the portion where the carbon fiber 9 is attached to the conductive base 12.

A description will be given herein below to a method for forming the conductive coating layer 10. By irradiating at least a part of the attached portion of the carbon fiber 9 with an electron beam in a chamber into which an organic gas containing a conductive element has been introduced, the conductive coating layer 10 with a sufficient thickness can be formed in a short period of time. In accordance with the method, it makes possible to locally coat the conductive coating layer 10 only at the bonded portion between the carbon fiber and the conductive base, and to reinforce the bonding without adhesion of the conductive coating element to the carbon fiber 9 protruding from the conductive base 12.

As the organic gas containing the conductive element, an organic gas which is decomposed only with a high-energy heavy ion beam, such as a gallium ion beam used normally in a FIB process or the like, cannot be used. This is because, if the carbon fiber is irradiated with the high-energy heavy ion beam, the carbon fiber is damaged momentarily so that a breakage or an irradiation-induced defect occurs therein. To prevent this, an electron beam of 100 keV or less which does not damage the carbon fiber is used preferably as a particle beam used to decompose the organic gas. As the organic gas, a pyrene monomer gas, a tungsten carbonyl gas, or the like which is decomposed with an electron beam of 100 keV or less and vaporized at a temperature of 100° C. or lower is used preferably. By irradiating such an organic gas with an electron beam, it makes possible to locally form only the bonded portion between the carbon fiber and the conductive base with a conductive material such as a carbon layer, a tungsten layer, or the like.

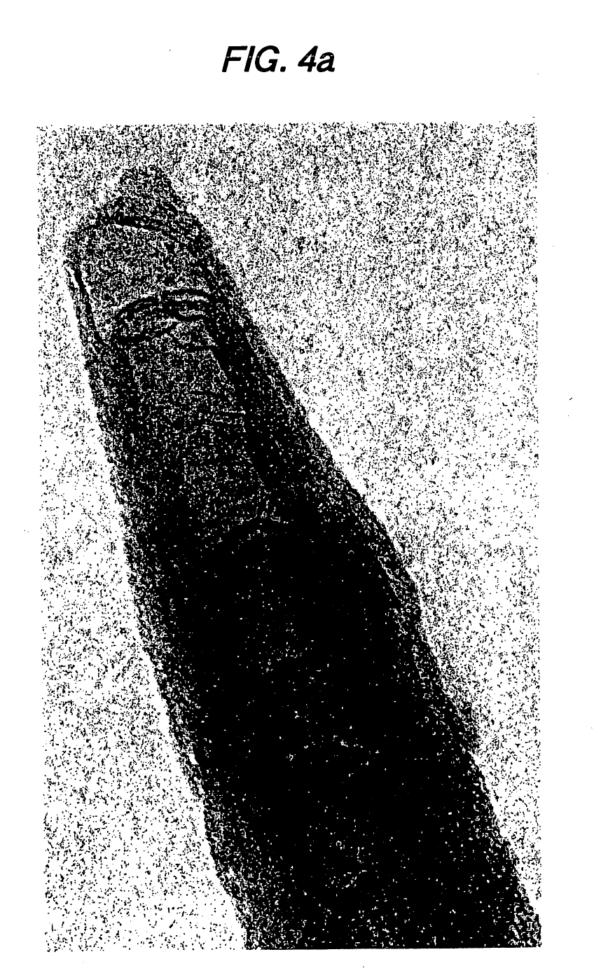

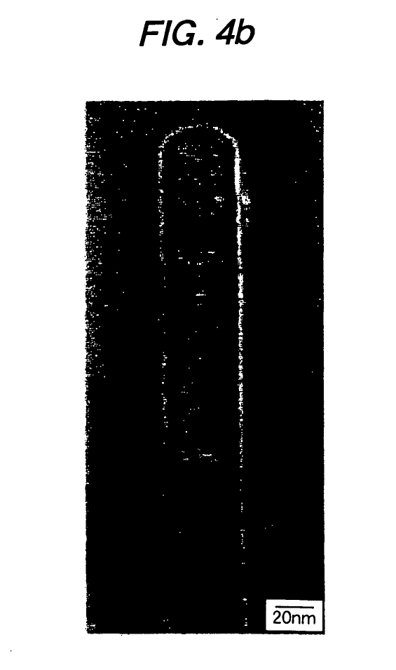

FIG. 4a and 4b show TEM photographs of two type carbon fibers 9 containing nitrogen according to the present embodiment. Preferably, the carbon fiber 9 is configured to have a diameter of 20 nm to 200 nm and a length of several hundreds of nanometers to several tens of micrometers in terms of the characteristic of field electron emission, electric resistance, and durability. As shown in FIGS. 3A and 3B, the carbon fiber 9 containing nitrogen was composed of numerous knots and large amounts of nitrogen were contained in the knotty portions. The configuration of the carbon fiber 9 may also be hollow (tube) or solid and is not particularly limited provided that a desired characteristic of field electron emission is obtainable therefrom. The end of carbon fiber was opened or closed. FIG. 4a is carbon fiber that shuts the point. FIG. 4b is carbon fiber that is the opening of the point. When the end of the carbon fiber was closed, the emission current was steady.

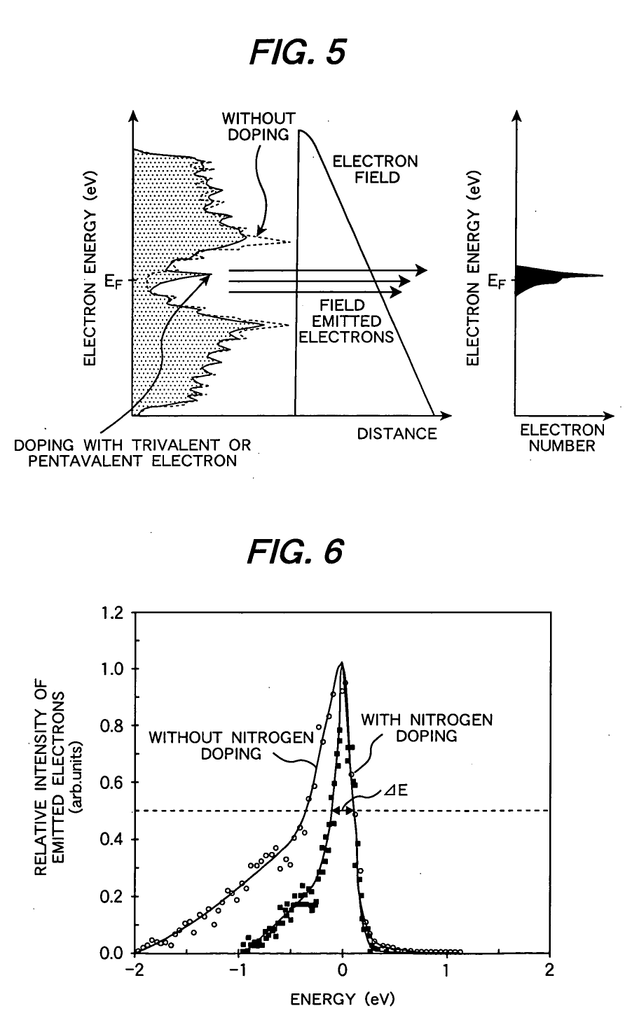

FIG. 5 shows a distribution of the density of states of free electrons in a carbon fiber 9 doped with a trivalent or pentavalent element such as boron or nitrogen, a potential distribution relative to electrons which are field emitted from the carbon fiber, and an energy distribution of the field emitted electrons. It has been proved by calculation that, by doping the carbon fiber with a trivalent or pentavalent element, the free electrons are localized in the vicinity of the Fermi level (E_{F}), as shown in FIG. 5. When an inward intensive electric field is applied to the carbon fiber 9, a potential barrier as shown in the FIG. 5 is formed by a potential which is formed by an external electric field and an image-force. When the thickness of the barrier reaches an 10 Å order, the free electrons localized in the vicinity of the Fermi level are emitted into vacuum by a quantum-mechanical tunneling effect so that an electron beam with a narrow energy width as shown in FIG. 5 is obtainable.

FIG. 6 shows the result of actually evaluating an effect of nitrogen doping exerted on the energy distribution of the field emitted electrons in the carbon fiber. The emission current obtained at this time was 1 μA. By the nitrogen doping, the energy half-width (ΔE) of the emitted electrons was halved from 0.4 eV to 0.2 eV.

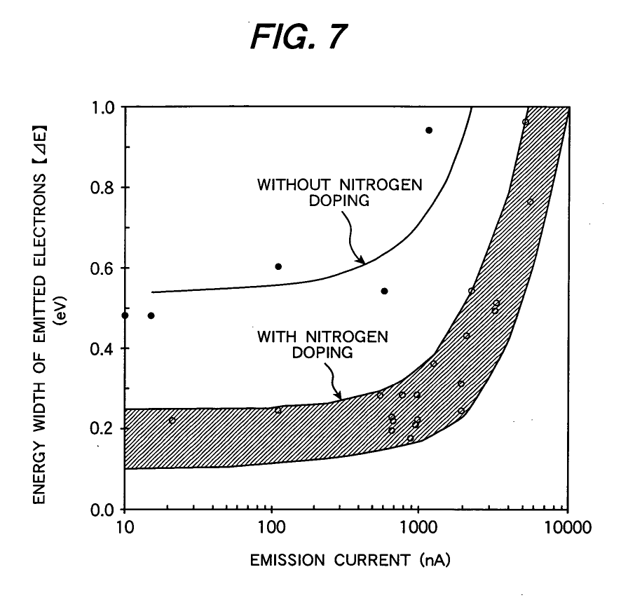

FIG. 7 shows the result of evaluating an effect of doping the carbon fiber 9 with nitrogen, which is exerted on the dependence of ΔE on an emission current.

As described above, these effects of doping lie in the fact that an emitted electron band is formed in a predetermined range and the energy width of the emitted electrons is consequently narrowed. Accordingly, it is expected that the same effects are also achievable with boron, as described above.

ΔE begins to narrow when the content of nitrogen becomes 0.1% or more as an atomic weight ratio of nitrogen to carbon and ΔE further narrow as the content of nitrogen increases. But when ΔE becomes 5% or more, a graphite layer composing the carbon fiber begins to be greatly deformed to suffer bending or the occurrence of numerous defects so that the mechanical property thereof is degraded. In view of this, the content of a trivalent or pentavalent doping element in the carbon fiber 9, which is represented by boron or nitrogen, is preferably 0.1% to 5% as an atomic weight ratio of the doping element to carbon.

The carbon fiber 9 doped with boron or nitrogen can be manufactured by a well-known method such as arc discharge, plasma synthesis, pulse laser vapor deposition, or vapor-phase pyrosynthesis. The content of the doping element in the manufactured carbon fiber 9 can be checked through compositional analysis using XPS, TEM-EELS, or the like.

Carbon fiber can be obtained by the following method.

(1) CNx Manufacturing Method

Synthetic method of CNx nanotubes is using a chemical vapor deposition (CVD). Most of the syntheses relies upon catalytic pyrolysis. A supporting catalyst Fe2O3/Ai2O3 was prepared by sol-gel method. Aluminum tri-sec-butoxide (8 g) was dissolved in 50 ml methanol, and a diluted HCl (0.01 mM) solution was added until a clear solution was obtained under stirring. Ferric nitrate Fe(NO3)3.9H2O(3.2 g) was then added into the solution. A gel was formed when liquid ammonia (2 ml) was added under stirring. The products were dried at 100° C. overnight and calcinated at 600° C. for 10 hours to form support catalyst. CNx nanotubes were prepared in a CVD apparatus consisting of a tube furnace. Mass flow was controlled under strict accuracy of 0.1 ml for all gases. The catalyst was placed into a quartz boat and then put in a quartz tube mounted in the tube furnace. Argon gas was passed through quartz tube under 200 standard cubic centimeters per minute (sccm) as the furnace was heated to 800° C. The catalyst was activated by introducing hydrogen (100 sccm) when the furnace was heated to 800° C. After reducing iron oxide for 1 hour, dimethylformamide, (HOCN(CH3)2, aerosol was transported by carrier gas of argon (1000 sccm) into the quartz tube. Anhydrous ammonia (100 sccm) was simultaneously introduced to produce CNx nanotubes.

(2) Another CNx Manufacturing Method

Carbon fiber can be made by other following methods. A mixture of powdered melamine and ferrocene (melamine:ferrocene=4:1) was introduced into a quartz tube mounted in the tube furnace. The melamine/ferrocene mixture was heated to 1050° C. for 15 min under Ar gas flowing.

(3) CBx Manufacturing Method

CBx is produced by laser vaporization method. A target is placed in a quartz tube and heated to 1100° C. in an argon atmosphere at 500 Torr. Nd:YAG laser (1064 nm, 10 Hz) was used to ablate a target which contained 0.5 to 10 at % boron and 0.5 at % of same amount of Co and Ni in carbon paste. The target was prepared by hot press of the carbon paste under 2 metric tons at 200°. The targets were heated at 1000° C. under argon gas atmosphere for 4 hours. Products resulting from the ablation of a target with boron content >3.5 at % contained an encapsulated boron carbide particle.

(4) Manufacturing Method of Surface Layer CBX

Penetration of boron from surface of the carbon nanotubes was carried out by chemical modification of CNT by substitution of the carbon atoms incorporating to the boron atoms. The set-up consists of a ceramic tube in high temperature furnace with a crucible in the middle of the furnace tube. After the 5:1 ratio of boron oxide and CNTs of mixture was placed in the crucible, ammonia gas was introduced (1×10-6 to 1×10-4 mbar) into the furnace where crucible was exposed for reaction of B-doping on the surface layers of the CNTs at 1150° C.

By using the field emission electron gun composed of a length of carbon fiber 9 containing at least one of trivalent and pentavalent elements described above, a high-brightness electron beam with a narrow energy width can be obtained.

(Application 1 to Electron Beam Apparatus)

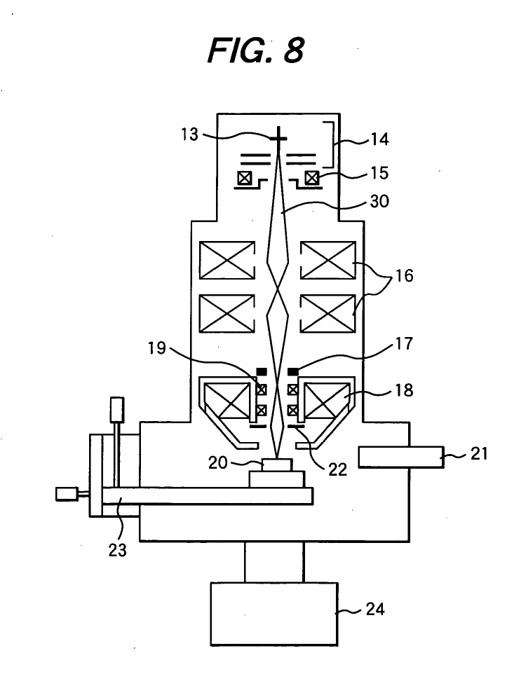

FIG. 8 is an overall structural view of a scanning electron microscope (SEM) using the electron gun according to the present invention. In the scanning electron microscope, an alignment coil 15, a condenser lens 16, an astigmatic correction coil 17, a deflection/scanning coil 19, an objective lens 18, and an objective aperture 22 are arranged along an electron beam emitted from the electron gun 14. A specimen 20 is placed on a specimen stage 23 to be irradiated with the electron beam. A secondary electron detector 21 is provided on the sidewall portion of a specimen chamber. The specimen chamber is designed for the maintenance of high vacuum by an evacuation system. In the scanning electron microscope thus constituted, the electron beam emitted from the electron gun 14 is accelerated by an anode and focused by electron lenses 16 and 18 to irradiate an extremely small region of the surface of the specimen 20. The irradiated region is subjected to two-dimensional scanning, secondary electrons emitted from the specimen 20, reflected electrons, and the like are detected by using the secondary electron detector 21, and an enlarged image is formed based on a difference between the respective amounts of detection signals.

By applying the electron gun according to the present invention to the scanning electron microscope, it makes possible to realize a scanning electron microscope capable of providing a secondary electron and a reflected electron image which are much higher in resolution and brightness than those provided by conventional models in a short period of time.

Since the basic structure of an electro-optic system in a length-measuring SEM which performs the observation of a micro fabricated pattern and the measurement of the length thereof in a semiconductor process is the same as shown in FIG. 8, the same effects are achievable by applying the electron gun according to the present invention thereto.

The structure of the scanning electron microscope in which the field emission electron gun 14 is to be mounted is not limited to the one shown in FIG. 8. A conventionally well-known structure can be adopted provided that the characteristics of the field emission electron gun can be derived sufficiently therefrom.

(Application 2 to Electron Beam Apparatus)

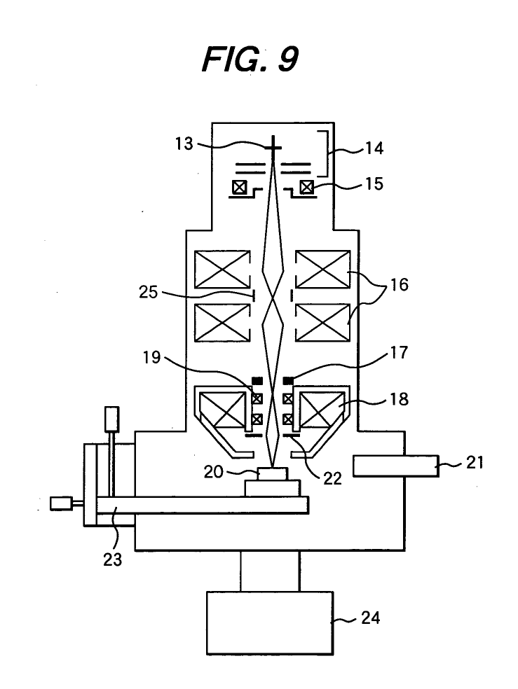

FIG. 9 shows an example of the overall structure of an electron beam lithography system in which the electron gun according to the present invention is mounted. The basic structure of an electro-optic system is substantially the same as in the scanning electron microscope described above. An electron beam obtained through field emission from the electron gun 14 is focused by a condenser lens 16 and focused onto a specimen 20 by an objective lens 19 to provide a beam spot on a nanometer order. At this time, the center of a blanking electrode 25 for controlling the turning ON/OFF of the electron beam which irradiates the specimen preferably coincides with a cross-over point formed by the condenser lens 16.

Electron beam lithography is performed by irradiating the electron beam deflected and scanned to the surface of the specimen 20 with the deflection/scanning coil 18, while turning ON/OFF the electron beam with the blanking electrode 25.

An electron beam lithography system is for forming various circuit patterns by irradiating a specimen substrate coated with a resist sensitive to an electron beam with an electron beam. As the definition of each of the various circuit patterns becomes higher, an electron gun capable of providing an extremely small probe diameter has been required. By applying the electron gun according to the present invention, an extremely small probe diameter can be obtained with much higher brightness than achieved by conventional models, which enables high-efficiency and high-definition electron beam lithography.

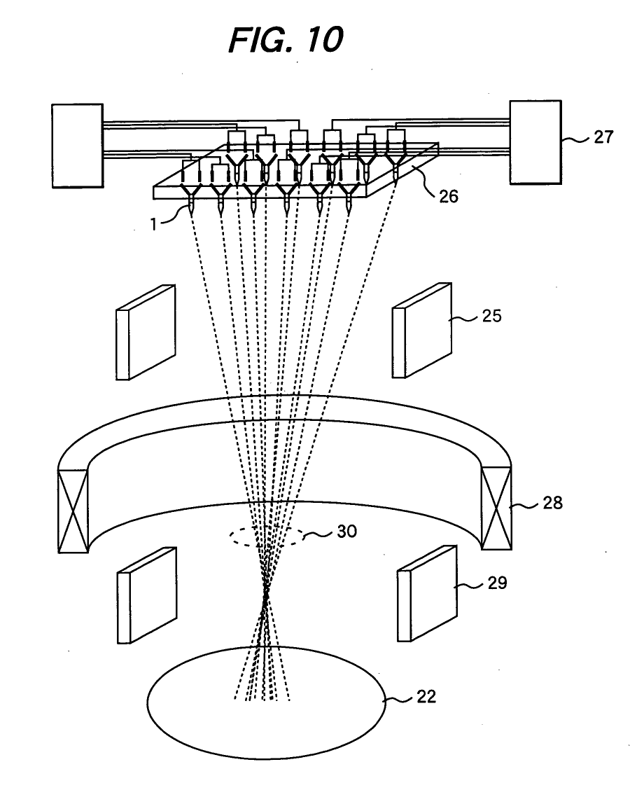

FIG. 10 shows a structural view of an electro-optical system in an electron beam lithography system in which a plurality of the independently operating electron guns 13 according to the embodiment are mounted through a electrode holder 26. By mounting a plurality of the field emission cathodes 1 according to the present invention and allowing independent voltage application to each of the cathodes 1 with an electrode driver 27 as shown in FIG. 10, it becomes possible to perform simultaneous irradiation of a specimen with a large number of electron beams and simultaneous lithography. Consequently, the efficiency of lithography can be improved exponentially. In FIG. 10., 28 is an electron lens, 29 is reflector.

What is claimed is:

1. A field emission electron gun comprising:
a field emission cathode comprised of a carbon fiber and a conductive base for supporting the carbon fiber;
an extractor for causing field emission of electrons from the field emission cathode; and
an accelerator for accelerating electrons emitted with the field emission, wherein
the carbon fiber contains at least one of trivalent and pentavalent elements.

2. The field emission electron gun according to claim 1, wherein the element contained in the carbon fiber is either or both of boron and nitrogen.

3. The field emission electron gun according to claim 1, wherein a content of the element contained in the carbon fiber is at least 0.1% to 5% at an atomic weight ratio of the contained element to carbon.

4. The field emission electron gun according to claim 1, wherein the carbon fiber has a diameter of 20 nm to 200 nm.

5. A field emission electron gun comprising:
a field emission cathode comprised of a carbon fiber and a conductive base for supporting the carbon fiber;
an extractor for causing field emission of electrons from the field emission cathode; and
an accelerator for accelerating electrons emitted with the field emission, wherein
when the emission current is 10 nA, the energy half-width of the field emission electrons is 0.25 eV or less.

6. A field emission electron gun comprising:
a field emission cathode comprised of a carbon fiber and a conductive base for supporting the carbon fiber;
an extractor for causing field emission of electrons from the field emission cathode; and
an accelerator for accelerating electrons emitted with the field emission, wherein
when the emission current is 1 μA, the energy half-width of the field emission electrons is 0.35 eV or less.

7. A field emission cathode for emitting electrons with the field emission,
Wherein the cathode is comprised of a carbon fiber and a conductive base for supporting the carbon fiber and used for the field emission electron gun as recited in claim 1.

8. A field emission electron microscope, wherein a field emission electron gun as recited in claim 1 is mounted.

9. A length-measuring SEM, wherein a field emission electron gun as recited in claim 1 is mounted.

10. An electron beam lithography system, wherein a field emission electron gun as recited in claim 1 is mounted.

11. An electron beam lithography system, wherein a plurality of field emission cathodes as recited in claim 1 is mounted.

12. A field emission electron microscope, wherein a field emission electron gun as recited in claim 5 is mounted.

13. A length-measuring SEM, wherein a field emission electron gun as recited in claim 5 is mounted.

14. An electron beam lithography system, wherein a field emission electron gun as recited in claim 5 is mounted.

15. An electron beam lithography system, wherein a plurality of field emission cathodes as recited in claim 5 is mounted.

16. The field emission electron gun according to claim 1, wherein the amount of said trivalent element or pentavalent elements in the center part of carbon fiber is different from the amount in surface part.

17. The field emission electron gun according to claim 1, wherein said trivalent element or pentavalent elements there is at least in surface part of carbon fiber.
